(19) United States
(12) Patent Application Publication
(10) Pub. No.: US 2020/0210908 A1
(43) Pub. Date: Jul. 2, 2020

(54) DYNAMIC OPTIMIZATION FOR JOBS

(71) Applicant: Microsoft Technology Licensing, LLC, Redmond, WA (US)

(72) Inventors: Keqing Liang, Sunnyvale, CA (US); Wen Pu, Santa Clara, CA (US); Sahin C. Geyik, Redwood City, CA (US); Yu Wang, Sunnyvale, CA (US); Ying Chen, Palo Alto, CA (US); Yin Zhang, Sunnyvale, CA (US); Sumedha K. Swamy, San Jose, CA (US)

(73) Assignee: Microsoft Technology Licensing, LLC, Redmond, WA (US)

(21) Appl. No.: 16/232,862

(22) Filed: Dec. 26, 2018

(51) Int. Cl. G06Q 10/04; G06Q 40/02; G06F 17/18

(52) U.S. Cl. CPC G06Q 10/04; G06F 17/18; G06Q 40/02

(57) ABSTRACT

The disclosed embodiments provide a system for performing dynamic job bidding optimization. During operation, the system obtains historical data containing a time series of interactions with a job. Next, the system uses the historical data to calculate an initial price of a job based on a predicted number of interactions with the job. The system then determines a first dynamic adjustment to the initial price that improves utilization of a budget for the job and a second dynamic adjustment to the initial price that improves a performance of the job. Finally, the system applies the first and second adjustments to the initial price to produce an updated price for the job and delivers the job within an online system based on the updated price.

### BACKGROUND

### Field

The disclosed embodiments relate to delivery of jobs in online systems. More specifically, the disclosed embodiments relate to techniques for performing dynamic optimization for jobs.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for performing dynamic optimization of job bids in accordance with the disclosed embodiments.

FIG. 3 shows a flowchart illustrating a process of performing dynamic optimization of job bids in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing dynamic optimization of job bids. The jobs are posted within an online system such as an online professional network and/or online marketplace. Each job is associated with a daily and/or other time-based budget that is spent as users view, click on, apply to, and/or perform other actions related to the job. As a result, bid prices for each job may be dynamically adjusted so that the job's budget can be consumed over the course of the day instead of running out too early and/or failing to be used up by the end of the day. Bid prices for jobs may also, or instead, be dynamically adjusted to improve application rates, applicant quality, and/or other performance factors related to the jobs.

More specifically, the disclosed embodiments select initial prices for the jobs based on predictions of subsequent interactions with the jobs and/or budgets for the jobs. For example, one or more models may be used to predict the number of views, clicks, applications, and/or other types of interactions with a job over a day based on historical time-series data associated with the interactions. An initial price for the job may then be calculated by dividing the job's daily budget by the predicted number of interactions, subject to an upper and/or lower bound.

Next, dynamic adjustments to the initial prices are determined to improve utilization of the jobs' budgets and/or the performance of the jobs. For example, a dynamic adjustment for improving utilization of a job's budget may be calculated based on the actual spending for the job at the current time and an expected spending for the job generated by a pacing curve for the job at the current time. In another example, a dynamic adjustment for improving the performance of the job may be calculated based on factors such as an application rate for the job, an application rate for a job segment of the job, an applicant quality associated with applicants for the job, and/or an application quality associated with applications to jobs in the job segment.

The dynamic adjustments are then applied to the initial price to produce an updated price for the job, and the updated price is used to control and/or adjust delivery of the job and/or interaction-based performance of the job (e.g., applications, quality applicants, etc.) within the online system. For example, the updated price may be combined with other factors into a score for the job, and the score may be selected as a recommendation, ranked, and/or otherwise delivered in the online system based on the score. A higher value of the updated price improves the score and potentially increase the visibility and/or delivery of the job, while a lower value of the updated price reduces the score and potentially decrease the visibility and/or delivery of the job.

By dynamically setting and adjusting bid prices of jobs based on objectives related to the jobs' budget utilization, performance, and/or popularity, the disclosed embodiments increase utilization of the job's budgets, improve the value of the jobs to posters of the jobs and applicants to the jobs, and/or allow delivery of the jobs to reflect recent feedback and/or activity related to the jobs. In contrast, conventional techniques generate bid prices for the jobs based on static rate cards, which have fixed prices for jobs. Such static, fixed pricing of jobs can result in suboptimal budget utilization (e.g., when a job's fixed price fails to consume the job's budget or overshoots the job's budget), performance (e.g., recommending of jobs with the same fixed price to applicants instead of tailoring job recommendations to the applicants' behavior and/or characteristics), and/or user experiences (e.g., sub-optimal job search experiences by the applicants due to lack of customization and/or irrelevant jobs in search results) associated with the jobs. Consequently, the disclosed embodiments may provide improvements in computer systems, applications, user experiences, tools, and/or technologies related to delivering online content and/or carrying out activities within online systems.

### Dynamic Optimization for Jobs

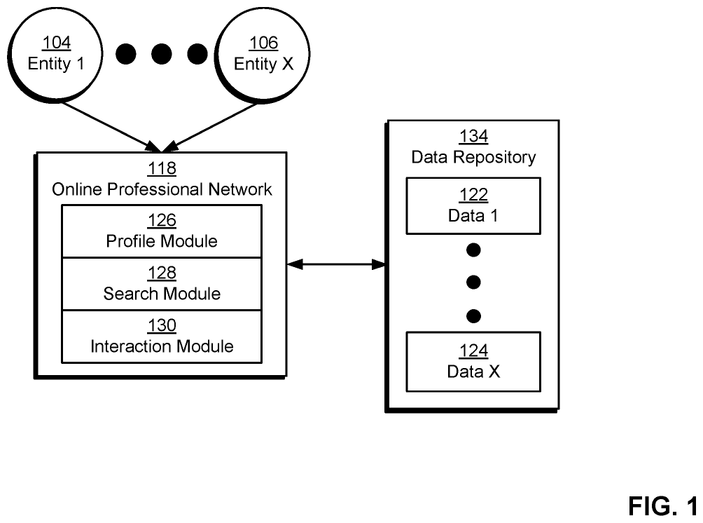

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that delivers, to the entities, the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 may then be used to generate recommendations and/or other insights related to listings of jobs or opportunities within online network 118. For example, one or more components of online network 118 may track searches, clicks, views, text input, applications, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

In one or more embodiments, data repository 134 stores data that represents standardized, organized, and/or classified attributes for the users or entities. For example, skills in data repository 134 may be organized into a hierarchical taxonomy. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve other data that is represented by the time periods (e.g., starting a job in a given month or year, graduating from university within a five-year span, job listings posted within a two-week period, etc.).

More specifically, data in data repository 134 and one or more machine learning models are used to produce rankings related to candidates for jobs or opportunities listed within or outside online network 118. The candidates may include users who have viewed, searched for, or applied to jobs, positions, roles, and/or opportunities, within or outside online network 118. The candidates may also, or instead, include users and/or members of online network 118 with skills, work experience, and/or other attributes or qualifications that match the corresponding jobs, positions, roles, and/or opportunities.

After the candidates are identified, profile and/or activity data of the candidates may be inputted into the machine learning model(s), along with features and/or characteristics of the corresponding opportunities (e.g., required or desired skills, education, experience, industry, title, etc.). The machine learning model(s) may output scores representing the strengths of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights may improve the quality of the candidates and/or recommendations of opportunities to the candidates, increase user activity with online network 118, and/or guide the decisions of the candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may recommend highly ranked candidates for a position to recruiters and/or other moderators as potential applicants and/or interview candidates for the position. In a fourth example, the component(s) may recommend jobs to a candidate based on the predicted relevance or attractiveness of the jobs to the candidate and/or the candidate's likelihood of applying to the jobs.

Jobs, advertisements, and/or other types of content displayed or delivered within online network 118 may also be associated with time-based limitations or constraints. For example, posters of jobs may pay per click, application, and/or other action taken with respect to the jobs by members of online network 118. The posters may set daily budgets for the jobs, from which costs are deducted as the members take the corresponding actions with the jobs. If a job's budget is fully consumed before the end of the day, the job may continue to be delivered to members (e.g., in search results and/or recommendations) until the end of the day without further charging the job's poster. Moreover, jobs with depleted budgets may occupy space in rankings that are shown to the members, which may prevent online network 118 from surfacing other jobs to the members and/or utilizing the budgets for the other jobs.

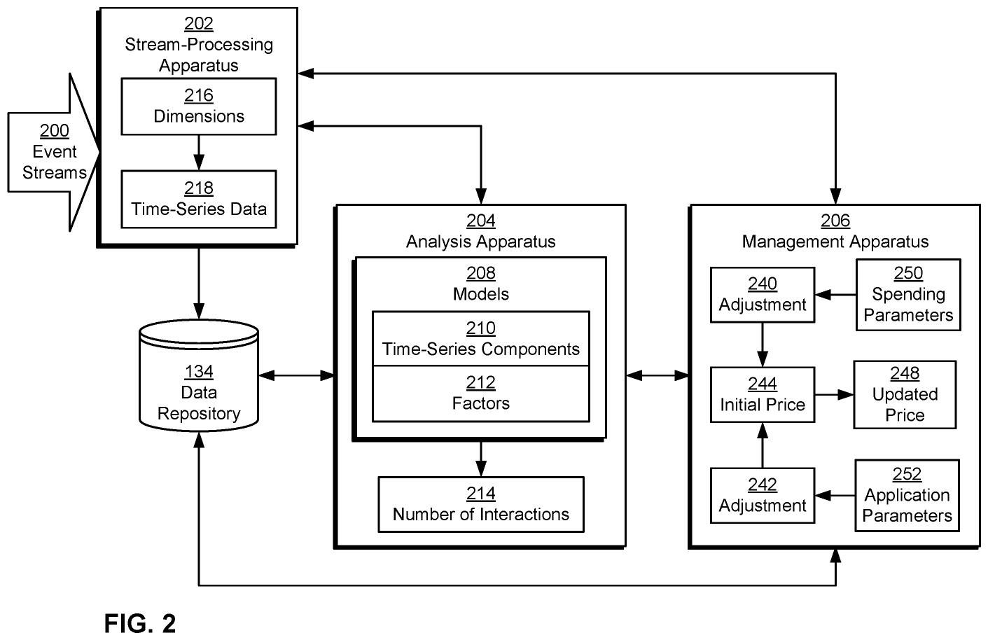

In one or more embodiments, online network 118 manages daily budgets and/or other constraints or priorities associated with jobs and/or other content in online network 118 by performing dynamic optimization of bid prices for the jobs. For example, online network 118 may calculate a new cost per click (CPC) for each job every time the job is outputted in search results and/or a ranking to one or more candidates. As described in further detail below with respect to FIG. 2, online network 118 may perform multiple adjustments to the bid prices to reflect anticipated interactions with the jobs, improve utilization of the jobs' budgets, increase the jobs' performance with respect to applications or applicants, and/or accommodate other optimization objectives. As a result, the bid prices may allow for a more even exposure of members to the jobs and/or may better reflect the “values” of the jobs within online network 118 and/or recent interactions or feedback related to the jobs.

FIG. 2 shows a system for performing dynamic optimization of job bids in accordance with the disclosed embodiments. The system includes a stream-processing apparatus 202, an analysis apparatus 204, and a management apparatus 206. Each of these components is described in further detail below.

Stream-processing apparatus 202 processes event streams 200 containing records of page views, clicks, and/or other activity collected from the monitored systems; performance metrics associated with the activity, such as page load times; and/or other time-series data from the monitored systems. In one or more embodiments, event streams 200 are generated and/or maintained using a distributed streaming platform such as Apache Kafka (Kafka™ is a registered trademark of the Apache Software Foundation). When a profile update, job search, job view, job click, job application, response to a job application, connection invitation, post, like, comment, share, purchase, conversion, member registration, and/or other recent activity occurs within or outside an online system (e.g., online network 118 of FIG. 1), a publisher in the distributed streaming platform generates a record of the activity. The distributed streaming platform may then propagate the record to components subscribing to event streams 200, such as stream-processing apparatus 202.

As shown in FIG. 2, stream-processing apparatus 202 aggregates records of events from event streams 200 along one or more dimensions 216. In some embodiments, groupings of dimensions 216 by which events in event streams 200 are aggregated represent different “job segments” of jobs posted within the online system. For example, dimensions 216 may include job attributes, such as locations or regions of the jobs (e.g., states within the United States); a standardized language, industry, seniority, education, experience level, skills, and/or title associated with each job; a source of applications for the job (e.g., a jobs module or other onsite source within the online system or a company website or another offsite source that is external to the online system); a payment model for the job (e.g., pay per click (PPC) or a prepaid fixed price throughout the job's lifetime); and/or an availability of a standardized company name for an employer associated with the job. In turn, jobs in each job segment may share a set of common dimensions 216 (e.g., location, industry, seniority, experience level, source of job applications, payment model, availability of standardized company names, etc.).

In one or more embodiments, stream-processing apparatus 202 generates time-series data 218 from aggregated events in event streams 200. For example, stream-processing apparatus 202 may aggregate page views, clicks, applications, CPCs, and/or other types of activity into time-series data 218 based on identifiers for jobs, companies, candidates, and/or other entities in the online system and/or dimensions 216 associated with the jobs, job segments of the jobs, and/or candidates. Such aggregated metrics may include, but are not limited to, a median, a quantile (e.g., 90^{th} percentile), a variance, a mean, a maximum, a minimum, a count (e.g., number of views accumulated over the course of a day), a sum (e.g., a total spending on a job over a day), and/or other summary statistics.

In addition, stream-processing apparatus 202 may aggregate events from event stream 200 in a number of ways. For example, stream-processing apparatus 202 may aggregate sets of a pre-defined consecutive number (e.g., 1000) of events for a given location and key into a single aggregated record. Alternatively, stream-processing apparatus 202 may aggregate records received from event stream 200 along pre-specified intervals (e.g., five-minute intervals) independently of the number of events generated within each interval.

After time-series data 218 is produced, stream-processing apparatus 202 stores time-series data 218 in data repository 134 and/or another data store for subsequent retrieval and use. Stream-processing apparatus 202 may optionally transmit a portion of time-series data 218 directly to analysis apparatus 204, in lieu of or in addition to storing time-series data 218 in the data store.

Analysis apparatus 204 analyzes time-series data 218 from stream-processing apparatus 202 and/or data repository 134 to predict a number of interactions 214 with a job over a period. For example, analysis apparatus 204 may obtain a time series of clicks, applies, and/or other types of interactions with the job over a preceding number of days (e.g., after the job has been posted for a minimum number of days) and use the time series to estimate the occurrence of the same types of interactions over a subsequent day.

In one or more embodiments, analysis apparatus 204 uses one or more models 208 to predict number of interactions 214 based on time-series data 218. Models 208 include one or more forecasting models that determine one or more time-series components 210 associated with time-series data 218. For example, models 208 may include a basic exponential smoothing model that predicts number of interactions 214 for a given time step (e.g., a day, hour, minute, five minutes, etc.) based on a smoothing factor, a prediction from the previous time step, and the value of the time series at the previous time step. In another example, models 208 may include a Holt-Winters double or triple exponential smoothing model that predicts level, trend, and/or seasonal components of number of interactions 214 for a number of time steps and combines the components into a predicted number of interactions 214 for a current or subsequent time step.

Models 208 further include one or more regression models that characterize other factors 212 related to time-series data 218. For example, models 208 may include a linear regression model that combines a set of time series values associated with a given day of the week (e.g., view counts for all Mondays) and/or other attributes (e.g., the location of the job) with a set of weights to produce a correction factor related to a predicted number of interactions 214 that is generated using time-series components 210. The correction factor may be applied to (e.g., multiplied with) the predicted number of interactions 214 generated from time-series components 210 to obtain a “corrected” value for the predicted number of interactions 214.

After analysis apparatus 204 determines number of interactions 214 for a given job based on time-series components 210 and/or factors 212, analysis apparatus 204 outputs number of interactions 214 to data repository 134 and/or management apparatus 206. Management apparatus 206 includes functionality to set pricing for the job, which can include an initial price 244 for the job and/or a number of adjustments 240-242 to initial price 244 that reflect various optimization objectives associated with delivery of the job in the online system.

First, management apparatus 206 calculates initial price 244 based on number of interactions 214 and a budget for the job. For example, management apparatus 206 may obtain initial price 244 as a daily CPC for the job by dividing a daily budget for the job by the estimated number of clicks on the job over the next day, as determined by analysis apparatus 204. When a predicted number of interactions 214 with the job is unavailable (e.g., when the job lacks historical time-series data 218 that can be used to estimate or forecast number of interactions 214), management apparatus 206 may obtain initial price 244 from a rate card for jobs in the online system. Management apparatus 206 may also, or instead, calculate initial price 244 by dividing the job's daily budget by a forecasted number of interactions 214 associated with one or more other jobs in the same job segment as the job.

Next, management apparatus 206 determines adjustment 240 based on spending parameters 250 associated with the job to improve utilization of the job's budget. For example, management apparatus 206 may calculate adjustment 240 using the following formula:

f_{j,t}(Sa_{j,t},Sp_{j,t})=exp(1−Sa_{j,t}/Sp_{j,t})

In the above formula, f_{b}, represents adjustment 240 for job j at time t, Sa_{j,t} represents an actual spending for the job at that time, and Sp_{j,t} represents the expected spending for the job at that time. The actual spending may be obtained from stream-processing apparatus 202 and/or another source of real-time or near-real-time data in the online system. The expected spending may be calculated from a pacing curve that is used to adjust delivery of the job so that the job's budget is consumed over the course of a period spanned by the budget (e.g., a day) instead of having the budget run out prematurely or fail to be fully consumed by the end of the period.

Continuing with the above example, adjustment 240 may have a lower bound of 0 due to properties of the exponential function. When the actual spending is lower than the expected spending, the value of the exponent is greater than 1, and adjustment 240 increases initial price 244. When the actual spending is higher than the expected spending, the value of the exponent is less than 1, and adjustment 240 reduces initial price 244.

Management apparatus 206 optionally limits adjustment 240 to fall within one or more boundaries. For example, management apparatus 206 may enforce a lower and/or upper bound on adjustment 240 to ensure that adjustment 240 does not result in excessive underdelivery and/or overdelivery of the job.

Management apparatus 206 also determines adjustment 242 based on application parameters 252 associated with applications to the job to improve the performance of the job. For example, management apparatus 206 may calculate adjustment 242 using the following formula:

f_{m,j}(h_{apply},h_{quality})=(applyrateⱼ/applyrate_{segment})*(qualityⱼ/quality_{segment})

In the above formula, f_{m,j} represents adjustment 242 for job j and member m (e.g., a candidate for the job), h_{apply} represents a measure of application rates associated with the job, and h_{quality} represents a measure of applicant quality associated with the job. Continuing with the above formula, applyrateⱼ represents the application rate for the job (e.g., the number of applications to the job divided by the number of impressions of the job over a given period), applyrate_{segment} represents the application rate for the job segment of the job (e.g., the number of applications to jobs in the job segment divided by the number of impressions of jobs in the job segment over a given period), qualityⱼ represents an average measure of quality for candidates of the job (e.g., an average “quality score” representing the extent to which the candidates are qualified for the job), and quality_{segment} represents an average measure of quality for candidates of jobs in the job segment (e.g., an average quality score representing the extent to which the candidates are qualified for jobs in the job segment).

As a result, adjustment 242 may increase initial price 244 when the job's application rate falls the job segment's application rate and/or the job's applicant quality falls below the job segment's applicant quality. Conversely, adjustment 242 may decrease initial price 244 when the job's application rate is higher than the job segment's application rate and/or the job's applicant quality is higher than the job segment's applicant quality.

As with limiting of adjustment 240, adjustment 242 may be restricted to fall within one or more boundaries. For example, management apparatus 206 may enforce a lower and/or upper bound on adjustment 242 to ensure that adjustment 242 does not overly correct for differences in application rates and/or applicant quality between the job and the corresponding job segment.

Management apparatus 206 applies adjustments 240-242 to initial price 244 to obtain an updated price 248 for the job. For example, adjustments 240-242 may include scaling factors that are multiplied with initial price 244 to obtain updated price 248. Management apparatus 206 may optionally enforce upper and/or lower limits on updated price 248 to ensure that updated price 248 does not deviate too far from initial price 244 and/or meets a certain minimum or maximum value associated with the job and/or job segment.

Finally, management apparatus 206 uses updated price 248 to deliver the job within the online system. For example, management apparatus 206 may generate an overall score for each job as a weighted combination of a user's predicted likelihood of clicking, applying to, and/or otherwise interacting with the job; updated price 248; and/or other factors. Management apparatus 206 may then rank a set of jobs by descending score and display the ranking to the user. Since the user is more likely to take action on higher-ranked jobs than on lower-ranked jobs, ranking of the jobs based on updated price 248 may allow subsequent actions and/or spending on the jobs to be increased or decreased accordingly.

By dynamically setting and adjusting bid prices of jobs based on objectives related to the jobs' budget utilization, performance, and/or popularity, the disclosed embodiments may increase utilization of the job's budgets, improve the value of the jobs to posters of the jobs and applicants to the jobs, and/or allow delivery of the jobs to reflect recent feedback and/or activity related to the jobs. In contrast, conventional techniques may generate bid prices for the jobs based on static rate cards, which can result in suboptimal budget utilization, performance, and/or user experiences associated with the jobs. Consequently, the disclosed embodiments may provide improvements in computer systems, applications, user experiences, tools, and/or technologies related to delivering online content and/or carrying out activities within online systems.

Those skilled in the art will appreciate that the system of FIG. 2 may be implemented in a variety of ways. First, stream-processing apparatus 202, analysis apparatus 204, management apparatus 206, and data repository 134 may be provided by a single physical machine, multiple computer systems, one or more virtual machines, a grid, one or more databases, one or more filesystems, and/or a cloud computing system. Stream-processing apparatus 202, analysis apparatus 204, and management apparatus 206 may additionally be implemented together and/or separately by one or more hardware and/or software components and/or layers.

Second, a number of techniques may be used to determine time-series components 210, factors 212, number of interactions 214, initial price 244, adjustments 240-242, updated price 248, and/or other values related to dynamic optimization of bid prices for jobs. For example, the functionality of analysis apparatus 204 and/or management apparatus 206 may be provided by various multi-objective optimization techniques, machine learning models, and/or other computational or technological solutions. In another example, adjustments 240-242 and/or other adjustments to initial price 244 may be based on a variety of factors, such as (but not limited to) multiple types of interactions with the job, costs for different types of interactions with the jobs, different measures of applicant quality associated with the jobs, and/or mechanisms for improving the diversity and/or variety of jobs shown to the applicants.

Third, the functionality of the system may be adapted to various types of activities and/or pricing. For example, the system may be used to adjust the pricing and/or delivery of advertisements, posts, images, audio, video, and/or other types of online content to reflect limitations, constraints, priorities, and/or requirements associated with the availability, budgets, and/or “value” of the content.

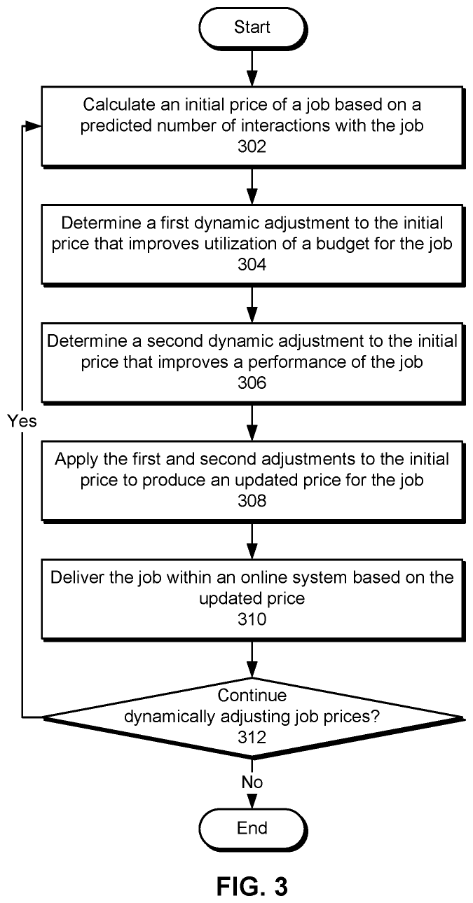

FIG. 3 shows a flowchart illustrating a process of performing dynamic optimization of job bids in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

The process begins with calculating an initial price of a job based on a predicted number of interactions with the job (operation 302). For example, one or more models may be applied to a historical time series of interactions (e.g., views, clicks, applies, etc.) with the job to predict a subsequent number of the same kind of interactions with the job. The models may include one or more forecasting models that determine a level, trend, and/or seasonality component associated with the time series, as well as one or more regression models that characterize other weekly seasonality factors (e.g., a “day of the week” effect on the interactions) and/or other factors that affect the time series. The output of the regression models may be combined with the output of the forecasting models to produce the predicted number of interactions, and the job's budget may be divided by the predicted number of interactions to obtain the initial price of the job.

Next, a first dynamic adjustment to the initial price that improves utilization of a budget for the job is determined (operation 304). For example, the first dynamic adjustment may be calculated based on an actual spending for the job at a current time and an expected spending for the job at the current time.

A second dynamic adjustment to the initial price that improves the performance of the job is also determined (operation 306). For example, the second dynamic adjustment may be calculated based on application rates and/or applicant qualities associated with the job, a job segment of the job, an applicant to the job, a member segment associated with the applicant, and/or other groupings of jobs and/or applicants.

The first and second adjustments are applied to the initial price to produce an updated price for the job (operation 308). For example, the first and second adjustments may be multiplied with the initial price to obtain the updated price. The adjustments and/or updated price may also be subject to upper and/or lower bounds that limit the minimum and/or maximum value of the change to the initial price and/or the final updated price.

Finally, the job is delivered within an online system based on the updated price (operation 310). For example, the updated price may be combined with other factors to produce a score for the job, and the job may be displayed and/or ranked within emails to job seekers, a job search and/or job recommendation module in the online system, and/or other communications with the job seekers based on the score.

Operations 302-310 may be repeated while job prices are dynamically adjusted (operation 312) in the online system. For example, operations 302-310 may be performed every time a job is to be scored and/or ranked for subsequent delivery within the online system. As a result, the initial price, the first dynamic adjustment, the second dynamic adjustment, and the updated price for a given job may be periodically and/or continually updated based on feedback (e.g., interaction rates, spending, performance, etc.) associated with previous delivery of the job within the online system and/or previous prices or attributes associated with the job.

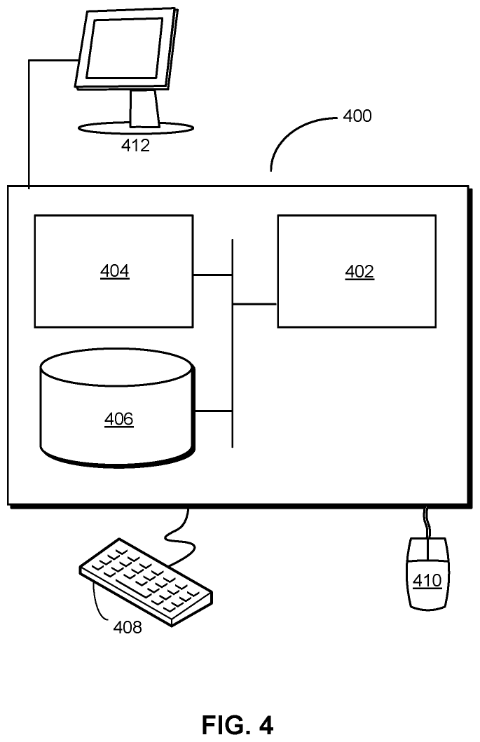

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for performing dynamic job bidding optimization. The system includes a stream-processing apparatus, an analysis apparatus, and a management apparatus, one or more of which may alternatively be termed or implemented as a module, mechanism, or other type of system component. The stream-processing apparatus obtains historical data containing a time series of interactions with a job. Next, the analysis apparatus and management apparatus use the historical data to calculate an initial price of a job based on a predicted number of interactions with the job. The management apparatus then determines a first dynamic adjustment to the initial price that improves utilization of a budget for the job and a second dynamic adjustment to the initial price that improves a performance of the job. Finally, the management apparatus applies the first and second adjustments to the initial price to produce an updated price for the job and delivers the job within an online system based on the updated price.

In addition, one or more components of computer system 400 may be remotely located and connected to the other components over a network. Portions of the present embodiments (e.g., stream-processing apparatus, analysis apparatus, management apparatus, data repository, online network, etc.) may also be located on different nodes of a distributed system that implements the embodiments. For example, the present embodiments may be implemented using a cloud computing system that controls the delivery of jobs, advertisements, and/or other content to a set of remote users based on constraints associated with the content's pricing, delivery, and/or budgets.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, by one or more computer systems, a first dynamic adjustment to an initial price of a job that improves utilization of a budget for the job;
determining, by the one or more computer systems, a second dynamic adjustment to the initial price that improves a performance of the job;
applying, by the one or more computer systems, the first and second adjustments to the initial price to produce an updated price for the job; and
delivering the job within an online system based on the updated price.

2. The method of claim 1, further comprising:
calculating the initial price of the job based on a predicted number of interactions with the job.

3. The method of claim 2, wherein calculating the initial price of the job based on the predicted number of interactions with the job comprises:
applying one or more models to historical data comprising a time series of interactions with the job to generate the predicted number of interactions with the job; and
dividing the budget by the predicted number of interactions to obtain the initial price of the job.

4. The method of claim 3, wherein the one or more models comprise a forecasting model that generates the predicted number of interactions with the job based on one or more components of the time series of interactions.

5. The method of claim 4, wherein the one or more components comprise at least one of:
a level;
a trend; and
a seasonality.

6. The method of claim 3, wherein the one or more models comprise a regression model that generates a seasonal factor associated with the predicted number of interactions.

7. The method of claim 3, wherein the time series of interactions is associated with at least one of:
views of the job;
clicks on the job; and
applications to the job.

8. The method of claim 1, wherein determining the first dynamic adjustment to the initial price of the job that improves utilization of the budget for the job comprises:
calculating the first dynamic adjustment based on an actual spending for the job at a current time and an expected spending for the job at the current time.

9. The method of claim 1, wherein determining the first dynamic adjustment to the initial price of the job that improves utilization of the budget for the job comprises:
limiting the first dynamic adjustment to fall between an upper bound and a lower bound.

10. The method of claim 1, wherein determining the second dynamic adjustment to the initial price that improves the performance of the job comprises:
calculating the second dynamic adjustment based on a first application rate for the job and a second application rate for a job segment of the job.

11. The method of claim 1, wherein determining the second dynamic adjustment to the initial price that improves the performance of the job comprises:
calculating the second dynamic adjustment based on a first applicant quality associated with the job and a second applicant quality associated with a job segment of the job.

12. The method of claim 1, further comprising:
updating the initial price, the first dynamic adjustment, and the second dynamic adjustment based on feedback associated with delivering the job within the online system.

13. A system, comprising:
one or more processors; and
memory storing instructions that, when executed by the one or more processors, cause the apparatus to:
calculate an initial price of a job based on a predicted number of interactions with the job;
determine a first dynamic adjustment to the initial price that improves utilization of a budget for the job;
determine a second dynamic adjustment to the initial price that improves a performance of the job;
apply the first and second adjustments to the initial price to produce an updated price for the job; and
deliver the job within an online system based on the updated price.

14. The system of claim 13, wherein calculating the initial price of the job based on the predicted number of interactions with the job comprises:
applying one or more models to historical data comprising a time series of interactions with the job to generate the predicted number of interactions with the job; and
dividing the budget by the predicted number of interactions to obtain the initial price of the job.

15. The system of claim 14, wherein the one or more models comprise:
a forecasting model that generates the predicted number of interactions with the job based on one or more components of the time series; and
a regression model that generates a seasonal factor associated with the predicted number of interactions.

16. The system of claim 15, wherein the one or more components comprise at least one of:
a level;
a trend; and
a seasonality.

17. The system of claim 14, wherein the time series of interactions is associated with at least one of:
views of the job;
clicks on the job; and
applications to the job.

18. The system of claim 13, wherein determining the first dynamic adjustment to the initial price of the job that improves utilization of the budget for the job comprises:
calculating the first dynamic adjustment based on an actual spending for the job at a current time and an expected spending for the job at the current time.

19. The system of claim 13, wherein determining the second dynamic adjustment to the initial price that improves the performance of the job comprises:
calculating the second dynamic adjustment based on a first application rate for the job, a second application rate for a job segment of the job, a first applicant quality associated with the job, and a second applicant quality associated with the job segment.

20. A non-transitory computer-readable storage medium storing instructions that when executed by a computer cause the computer to perform a method, the method comprising:
determining a first dynamic adjustment to an initial price of a job that improves utilization of a budget for the job;
determining a second dynamic adjustment to the initial price that improves a performance of the job;
applying the first and second adjustments to the initial price to produce an updated price for the job; and
delivering the job within an online system based on the updated price.
